(19) United States
(12) Patent Application Publication
(10) Pub. No.: US 2017/0103352 A1
(43) Pub. Date: Apr. 13, 2017

(54) Viral Workflow System

(71) Applicant: ADP, LLC, Roseland, NJ (US)

(72) Inventors: Agatha Kurjanowicz, Ottawa (CA); Scott Crockett, New York, NY (US); Sirui Liu, New York, NY (US); Jesse S. Zolna, Larchmont, NY (US); Michael Thibodeau, Brooklyn, NY (US); Valérie Felger, Fort-de-France (MQ); David Philander Derby, New York, NY (US)

(21) Appl. No.: 15/054,679

(22) Filed: Feb. 26, 2016

Related U.S. Application Data
(60) Provisional application No. 62/240,632, filed on Oct. 13, 2015.

(51) Int. Cl. G06Q 10/06; G06Q 50/00

(52) U.S. Cl. CPC G06Q 10/0633; G06Q 50/01

(57) ABSTRACT

A computer system receives a challenge submitted from an employee. The computer system identifies other challenges that meets a policy identifying when the other challenges are related employee submitted challenge. The computer system combines the related challenges into a workflow, increasing the visibility of the related challenges throughout the organization, enabling performing operation for the organization based on employee driven innovations identified and distributed within the workflow.

### CROSS-REFERENCE TO RELATED APPLICATIONS

This application claims the benefit of U.S. Provisional Patent Application No. 62/240,632, filed Oct. 13, 2015, and entitled “Viral Workflow System.”

This application is also related to U.S. patent application Ser. No. ______, Attorney Docket No. ES2015030-1, entitled “Skill Training System”, and U.S. patent application Ser. No. ______, Attorney Docket No. ES2015031-1, entitled “Achievement Portfolio System”, each of which is filed even date hereof, assigned to the same assignee, and incorporated herein by reference.

### BACKGROUND INFORMATION

1. Field

The present disclosure relates generally to an improved computer system and, in particular, to a method and apparatus for accessing information in a computer system. Still more particularly, the present disclosure relates to a method and apparatus for accessing information about people in a computer system.

2. Background

Information systems are used for many different purposes. For example, an information system may be used to provide communication between, and distribute ideas amongst employees within an organization. Businesses rely on collaborative efforts facilitated by this communication to achieve the organizational goals of the business.

However, the information organization methods and systems that are currently used fail to facilitate collaborative efforts across departments, groups, teams, and individuals within the organization in pursuit of organizational goals. As a result, efforts performed by one department, group, team, or individual are often duplicated by other departments, groups, teams, or individuals who are unaware of the similar simultaneous efforts. Similarly, efforts expended on previously achieved goals are often not readily accessible to the department, group, team, or individual when working on a current project. Efforts performed on previously achieved goal are often lost and must be repeated.

Additionally, truly innovative grassroots ideas are often not effectively communicated and identified from the inventing employees. Currently used information systems often fail to effectively identify employee driven innovation within an organization. Truly innovative ideas that can potentially transform the organization often therefore go unnoticed within the organization, often hindering organizational goals and failing to identify the visionary ideas and employees within the organization.

Therefore, it would be desirable to have a method and apparatus that take into account at least some of the issues discussed above, as well as other possible issues. For example, it would be desirable to have a method and apparatus that overcome a technical problem of facilitating collaborative efforts within an organization that makes the identification identifying employee driven innovations and prevention of repetitive efforts in pursuit of organizational goals more cumbersome and time-consuming than desired.

### SUMMARY

An embodiment of the present disclosure provides a method for creating viral Workflows in an organization. A computer system receives a challenge submitted from an employee. The computer system identifies other challenges that meets a policy identifying when the other challenges are related employee submitted challenge. The computer system combines the related challenges into a workflow, increasing the visibility of the related challenges throughout the organization, enabling performing operation for the organization based on employee driven innovations identified and distributed within the workflow.

Another embodiment of the present disclosure provides a computer system comprising a display system and a viral Workflow generator in communication with the display system. The viral Workflow generator receives a challenge submitted from an employee. The viral Workflow generator identifies other challenges that meets a policy identifying when the other challenges are related employee submitted challenge. The viral Workflow generator combines the related challenges into a workflow, increasing the visibility of the related challenges throughout the organization, enabling performing operation for the organization based on employee driven innovations identified and distributed within the workflow.

Yet another embodiment of the present disclosure provides computer program product for creating viral Workflows in an organization comprising a computer readable storage media, and first program code, second program code, third program code, and fourth program code stored on the computer readable storage media. The first program code receives a challenge submitted from an employee. The second program code identifies other challenges that meet a policy identifying when the other challenges are related employee submitted challenge. The third program code combines the related challenges into a workflow, increasing the visibility of the related challenges throughout the organization, enabling performing operation for the organization based on employee driven innovations identified and distributed within the workflow.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of workflow management environment depicted in accordance with an illustrative embodiment;

FIG. 2 is an illustration of a block diagram of a data flow for identifying and distributing the employee driven innovations within an organization depicted in accordance with an illustrative embodiment;

FIG. 3 is an illustration of a tag depicted in accordance with an illustrative embodiment;

FIG. 4 is an illustration of a graphical user interface for creating a challenge depicted in accordance with an illustrative embodiment;

FIG. 5 is an illustration of a graphical user interface submitting a challenge to a workflow generator depicted in accordance with an illustrative embodiment;

FIG. 6 is an illustration of a graphical user interface for entering challenge details depicted in accordance with an illustrative embodiment;

FIG. 7 is an illustration of a graphical user interface for merging challenges into a Workflow depicted in accordance with an illustrative embodiment;

FIG. 8 is an illustration of a graphical user interface for displaying a Workflow depicted in accordance with an illustrative embodiment;

FIG. 9 is an illustration of a flowchart of a process for identifying and merging related challenges into a Workflow depicted in accordance with an illustrative embodiment; and

FIG. 10 is an illustration of a block diagram of a data processing system depicted in accordance with an illustrative embodiment.

### DETAILED DESCRIPTION

The illustrative embodiments recognize and take into account one or more different considerations. For example, the illustrative embodiments recognize and take into account that an employer may need to perform certain operations. The illustrative embodiments also recognize and take into account that performing these operations may be more cumbersome and time-consuming than desirable.

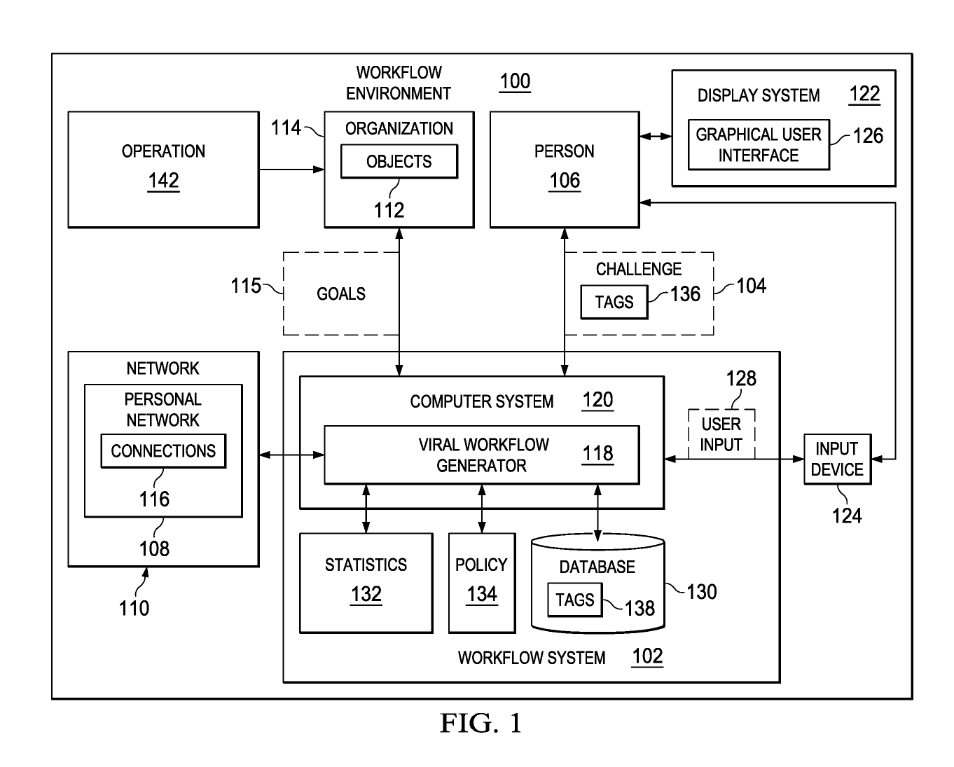

With reference now to the figures and, in particular, reference to FIG. 1, an illustration of a block diagram of a workflow management environment is depicted in accordance with an illustrative embodiment. In this illustrative example, workflow environment 100 includes workflow system 102. Workflow system 102 accepts the submission of challenge 104 from person 106, and provides access to personal network 108 for the social distribution of challenge 104. Workflow system 102 may distribute of challenge 104 to personal network 108 for may be at least one of reading, writing, modifying, storing, or deleting challenge 104 by person 106.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Network 110 is located in at least one of workflow system 102 or outside of workflow system 102. For example, network 110 may include at least one of a local area network (LAN), a wide area network (WAN), the Internet, an intranet, or some other suitable type of network. In an illustrative example, Network 110 is a social network structure that represents relationships among objects 112, and the flow of information between objects 112 of organization 114.

Each of objects 112 is represented as a discrete object within the network 110. Each of objects 112 is a person or group having a relationship with organization 114, an asset of organization 114, or other suitable object having a relationship with organization 114. Objects 112 can be, for example at least one of people, employees, customers, vendors, products, goals, activities, deliverables, offices, departments, services, business plans, performance reviews, payroll, human resources, benefits administration, business plans, marketing, research, product development, challenges, or other suitable objects.

In the illustrative example, organization 114 may be, for example, a corporation, a partnership, a charitable organization, a city, a government agency, or some other suitable type of organization. Person 106 may be an employee of organization 114. In other illustrative examples, person 106 may be a member of organization 114 without being an employee. Person 106 is represented as one of objects 112 in network 110.

Objects 112 can be associated with others of objects 112 to form personal network 108. In this illustrative example, personal network 108 is the personal network of person 106. Connections 116 are associated ones of objects 112 that form personal network 108. In these illustrative example, connections 116 are ones of objects 112 represented in network 110 that are associated with person 106.

Workflow system 102 accepts the submission of challenge 104 from person 106 for social distribution among personal network 108. In these illustrative example, workflow system 102 provides tagging of relevant content within challenge 104, enables viral sharing of challenge 104 throughout network 110, promotes cross-team alignment for similar challenges, fosters upstream communication within an organization 114 as challenge 104 is shared to additional personal networks, and encourages employee driven innovation through the promotion and distribution of challenge 104 submitted by person 106.

Challenge 104 is a submission from person 106 into workflow system 102 of challenge 104 to personal network 108 to target a new or existing business need of organization 114. Challenge 104 can address a business need, for example but not limited to, at least one of process improvements, tracking new work assignments for objects 112, posting requests for help to personal network 108 in order to achieve a formal goal of organization 114, and sharing ideas or innovations among personal network 108.

In contrast to challenge 104, goals 115 are broadly defined strategic objectives of organization 114. Goals 115 can be, for example but not limited to, at least one of a market standing of organization 114, development of new goods and services, selection and development of the employees, identification of capital resources, equipment and facilities utilized by organization 114, improvements in productivity, social responsibility of organization 114, and measurable financial goals of organization 114.

In an illustrative example, goals 115 are cascading goals. Cascading goals are organizationally driven goals aligning the organizational strategy into team and individual objectives. Cascading goals can be pushed down from leadership of organization 114 for incremental implementation by departments, groups, and individuals.

In one illustrative example, viral workflow generator 118 may be used to perform at least one of distributing of challenge 104 to personal network 108 to target an existing business need of organization 114. As depicted, viral workflow generator 118 be implemented in software, hardware, firmware or a combination thereof. When software is used, the operations performed by viral workflow generator 118 may be implemented in program code configured to run on hardware, such as a processor unit. When firmware is used, the operations performed by viral workflow generator 118 may be implemented in program code and data and stored in persistent memory to run on a processor unit. When hardware is employed, the hardware may include circuits that operate to perform the operations in viral workflow generator 118.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

As depicted, viral workflow generator 118 may be implemented in computer system 120. Computer system 120 is a hardware system that includes one or more data processing systems. When more than one data processing system is present, those data processing systems may be in communication with each other using a communications medium. The communications medium may be a network. The data processing systems may be selected from at least one of a computer, a server computer, a tablet, or some other suitable data processing system.

In the illustrative example, person 106 may interact with viral workflow generator 118 in computer system 120 to submit challenge 104 to viral workflow generator 118 for distribution among personal network 108. For example, person 106 may interact with viral workflow generator 118 in workflow system 102 to submit challenge 104 targeting an existing business need of organization 114, such as process improvements, to submit challenge 104 tracking new work assignments for objects 112, to submit challenge 104 posting requests for help to personal network 108 in order to achieve a formal goal of organization 114, and to submit challenge 104 sharing ideas or innovations among personal network 108.

As depicted, person 106 may interact with viral workflow generator 118 using display system 122 and input device 124. Graphical user interface 126 is displayed on display system 122 and provides visualization of objects 112 and associations among connections 116 form personal network 108. Additionally, graphical user interface 126 provides interaction with viral workflow generator 118.

As depicted, display system 122 is a hardware system and includes one or more display devices on which graphical user interface 126 may be displayed. The display devices may include at least one of a light emitting diode display (LED), a liquid crystal display (LCD), an organic light emitting diode display (OLED), or some other suitable device on which graphical user interface 126 can be displayed. Person 106 may interact with graphical user interface 126 through user input 128 generated by input device 124. Input device 124 may be, for example, a mouse, a keyboard, a trackball, a touchscreen, a stylus, or some other suitable type of input device.

In an illustrative example, person 106 may interact with viral workflow generator 118 through user input 128 to perform actions with respect to challenge 104. In the illustrative example, user input 128 can be used to perform actions with respect to challenge 104, such as for example but not limited to, at least one of viewing challenge 104, posting ideas to challenge 104, posting comments to challenge 104, uploading files to challenge 104, sharing challenge 104 with connections 116 within personal network 108, and associating challenge 104 with other challenges within database 130 to create a viral workflow.

In an illustrative example, person 106 interacts with graphical user interface 126 through user input 128 to share challenge 104 with connections 116 of personal network 108. By sharing challenge 104 with connections 116, person 106 enables connections 116 to perform actions with respect to challenge 104. Connections 116 perform actions such as but not limited to, at least one of viewing challenge 104, posting ideas to challenge 104, posting comments to challenge 104, uploading files to challenge 104, sharing challenge 104 with connections 116 within personal network 108, and associating challenge 104 with other challenges within database 130 to create a viral workflow.

As additional people share challenge 104 among their own personal networks, the visibility of challenge 104 increases within organization 114. Viral workflow generator 118 provides a sharing and promotion tool that identifies and encourages grass-root innovation within organization 114. The viral workflow generator 118 provides the social tools to make challenge 104 or workflow viral in nature. By leveraging individual connections, challenge 104 can grow in visibility as it is among the various connections 116 of different personal network 108 within organization 114. Viral workflow generator 118 supports employee driven innovation within organization 114, fueling bottom-up innovative ideas that can potentially transform organization 114.

Based on user input 128 performing actions with respect to challenge 104, as well as actions performed by connections 116 with respect to challenge 104, viral workflow generator 118 calculates statistics 132 about challenge 104. Statistics 132 are the results of an analysis of actions performed with respect to challenge 104. In this illustrative example, the analysis is a mathematical analysis that may identify information about actions performed with respect to challenge 104. The information may include statistics, such as for example, but not limited to, averages, normal distributions, and probabilities, as well as other information related to challenge 104, such as for example, but not limited to, viewing challenge 104, posting ideas to challenge 104, posting comments to challenge 104, uploading files to challenge 104, sharing challenge 104 with connections 116 within personal network 108, and associating challenge 104 with other challenges within database 130 to create a viral workflow.

Viral workflow generator 118 applies a group of rules in policy 134 to statistics 132. Based on the results of applying the group of rules to statistics 132, viral workflow generator 118 identifies whether challenge 104 is a trending activity.

For example, one rule in policy 134 may identify challenge 104 as a trending activity based on an analysis of all actions performed by any of objects 112 with respect to challenge 104 over a selected time period. Workflow generator 118 calculates trending activities based on an analysis of statistics 132 of the challenge 104. The selected time period is at least one of 30 days, 1 month, 1 day, 1 week, 3 months, 1 year, or some other suitable time period for identifying trends.

Additionally, viral workflow generator 118 applies a group of rules in policy 134 to challenge 104. Based on the results of applying the group of rules to challenge 104, viral workflow generator 118 identifies whether challenge 104 is related to objects 112.

For example, one rule in policy 134 may identify challenge 104 as related to similar objects 112 based on a comparison of tags 136 of challenge 104 to tags 138. As used herein, tags 136 are keywords or terms associated with challenge 104 that generally indicate the subject matter of challenge 104. Tags 138 are keywords or terms associated with objects 112 that generally indicate the subject matter of objects 112. As depicted, tags 136 and tags 138 can be subsets of tags 138. Tags 138 are all keywords or terms associated with any of objects 112. Viral workflow generator 118 identifies objects 112 as a related object based on comparison of tags 136 with tags 138. Objects 112 can be identified as a related object based on an overlap between tags 136 of challenge 104 and tags 138 of objects 112.

In this illustrative example, organization 114 may rely on both the identification of challenge 104 as a trending challenge the identification of objects 112 similar to challenge 104 to make decisions regarding the performance of operations 142 for achieving goals 115.

As a result, challenge 104 for can be more efficiently distributed among objects 112 of the network 110. Viral workflow generator 118 provides a sharing and promotion tool that identifies and encourages grass-root innovation within organization 114. The viral workflow generator 118 provides the social tools to make challenge 104 or workflow viral in nature. By leveraging individual connections, challenge 104 can grow in visibility as it is distributed among the various connections 116 of different personal network 108 within organization 114. Viral workflow generator 118 supports employee driven innovation within organization 114, fueling bottom-up innovative ideas that can potentially transform organization 114. In this manner, performing operation 142 for organization 114 is enabled based on the submission of challenge 104 by person 106, as well as the growing visibility of challenge 104 among other people within an organization 114.

The illustrative example in FIG. 1 and the examples in the other subsequent figures provide one or more technical solutions to overcome a technical problem of identifying employee driven innovations based on viral distribution of employee submitted challenges and alignment of those challenges with organizational goals that might otherwise go unrecognized or be more cumbersome and time-consuming than desired. For example, viral workflow generator 118 identifies challenge 104 as a trending activity based on an analysis of all actions performed by any of objects 112 with respect to challenge 104 over a selected time period. As another example, viral workflow generator 118 may identify challenge 104 as related to similar objects 112 based on a comparison of tags 136 of challenge 104 to tags 138.

In this manner, the use of viral workflow generator 118, has a technical effect of reducing time, effort, or both in identifying and distributing employee driven innovations. Viral workflow generator 118 leverages individual connections, linking similar challenges horizontally, both within and outside a team or department, as a challenge is shared within the company and grows in visibility. Viral workflow generator 118 generates a collaborative network of cross-organizational teams within organization 114 working together to achieve goals 115 of organization 114. In this manner, operations 142 performed for organization 114 may be performed more progressively and efficiently as compared to currently used systems for identifying generating workflows. For example, challenge 104 may be used in operation 142 to further one or more goals 115 of the organization 114.

As a result, computer system 120 operates as a special purpose computer system in which viral workflow generator 118 in computer system 120 enables identifying and distributing employee driven innovations within an organization 114. For example, viral workflow generator 118 enables identifying and distributing employee driven innovations based on the content and distribution of challenge 104 meeting policy 134. For example, challenge 104 may be identified as a trending activity based on an analysis of all actions performed by any of objects 112 with respect to challenge 104 over a selected time period. As another example, challenge 104 may be identified as related to similar objects 112 based on a comparison of tags 136 of challenge 104 to tags 138. In this manner, employee driven innovations, submitted as challenge 104, are identified based on viral distribution of employee submitted challenges and alignment of those challenges with organizational goals. Viral workflow generator 118 therefore enables identifying employee submitted innovative ideas that might otherwise go unrecognized or be more cumbersome and time-consuming than desired.

Thus, viral workflow generator 118 transforms computer system 120 into a special purpose computer system as compared to currently available general computer systems that do not have viral workflow generator 118. Currently used general computer systems do not enable identifying and distributing employee driven innovations within an organization. Further, currently used general computer systems do not provide for identifying and distributing employee driven innovations based on the content and distribution of challenge 104 meeting policy 134.

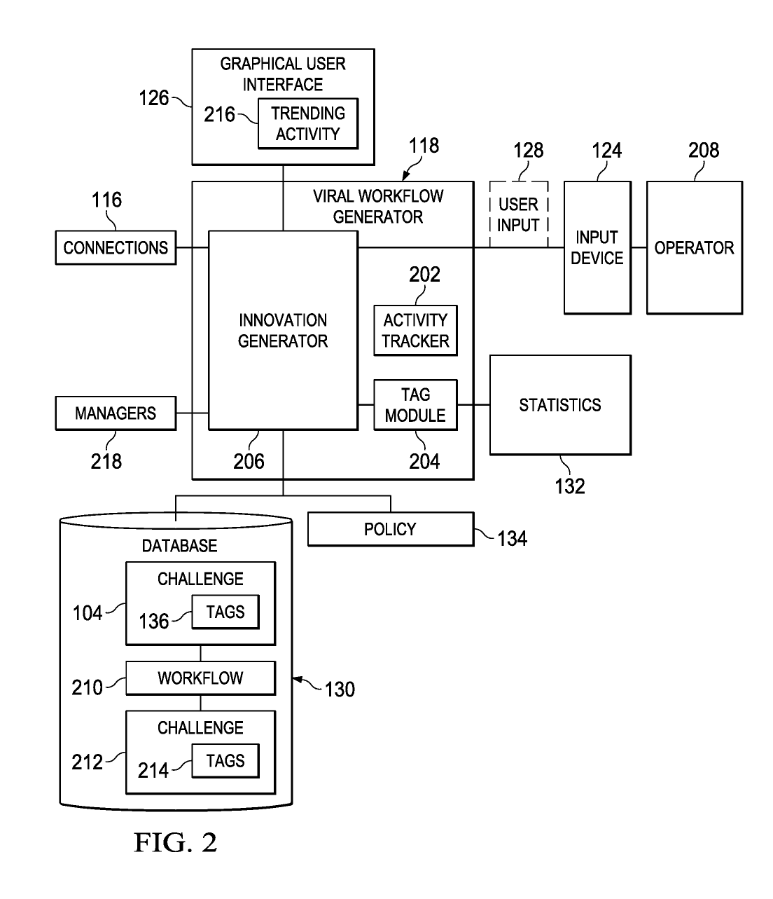

With reference next to FIG. 2, an illustration of a block diagram of data flow for identifying and distributing employee driven innovations within an organization is depicted in accordance with an illustrative embodiment. In this figure, an example of data flow for identifying similar challenges and trending activities that meet policy 134 through viral workflow generator 118 is shown. In the illustrative examples, the same reference numeral may be used in more than one figure. This reuse of a reference numeral in different figures represents the same element in the different figures.

As depicted, viral workflow generator 118 has a number of different components. As used herein, a “number of items” means one or more items. For example, “a number of different components” means one or more components. As depicted, viral workflow generator 118 includes activity tracker 202, tag module 204, and innovation generator 206.

Activity tracker 202 in viral workflow generator 118 tracks user input 128 performed by operator 208 with respect to challenges, such as challenge 104 of FIG. 1. As depicted, operator 208 is a person interacting with viral workflow generator 118, such as person 106 of FIG. 1. Additionally, operator 208 can be other persons, such as individuals within personal network 108 of person 106 of FIG. 1. In the illustrative example, operator 208 can perform actions with respect challenges 104 through user input 128 input into viral workflow generator 118 using input device 124. Activity tracker 202 can track user input 128 such as, but not limited to, at least one of viewing challenge 104, posting ideas to challenge 104, posting comments to challenge 104, uploading files to challenge 104, sharing challenge 104 with connections 116 within personal network 108, and associating challenge 104 with other challenges within database 130 to create a viral workflow. Share, follow and promote challenges to connections, Build workflows by linking together similar challenges, Comment on and register to contribute to a challenge, Merge challenges together. Activity tracker 202 records user input 128 performed with respect to challenge 104 as statistics 132.

As depicted, tag module 204 creates tags 136 for challenge 104. As used herein, tags 136 are keywords or terms associated with challenge 104 that generally indicate at least one of the subject matter of challenge 104 and information contained within challenge 104. Tags 136 are data structures and include information about challenge 104. Tags 136 may be stored as one of tags 138, shown in block form in FIG. 1, in at least one of database 130 or other suitable storage.

Innovation generator 206 within viral workflow generator 118 is a tool that facilitates encourages employee driven innovation through the promotion and distribution of challenge 104 submitted by person 106. Innovation generator 206 identifies employee driven innovations, submitted as challenge 104, based on viral distribution of challenge 104 among connections 116.

Innovation generator 206 enables viral distribution of challenge 104 among connections 116 based on user input 128 from operator 208. User input 128 allows operator 208 to take a number of actions with respect to challenge 104 that increase the visibility of challenge 104 within an organization 114. For example, operator 208 can take actions with respect to challenge 104, such as but not limited to, sharing challenge 104 among connections 116, following challenge 104, promoting challenge 104 to connections 116, commenting on challenge 104, and registering to contribute to challenge 104.

In this illustrative example, as operator 208 performs actions with respect to challenge 104, those actions become visible to connections 116 within the personal network 108 for operator 208. In an illustrative example, the actions performed by operator 208 can be displayed within graphical user interface 126 of connections 116 in personal network 108 of operator 208.

Innovation generator 206 therefore provides the social tools to make a challenge 104 viral in nature. As additional operators takes actions with respect to challenge 104, challenge 104 becomes more widely exposed throughout organization 114. By leveraging individual connections among personal network 108 for each of operators 208, challenge 104 can grow in visibility as it is shared within organization 114.

Innovation generator 206 enables creation of workflow 210 by linking challenge 104 with challenge 212. By linking challenge 104 with other similar challenges, innovation generator 206 generates a collaborative foundation for cross-organizational teams within organization 114 working together on workflow 210, in order to achieve goals 115 of organization 114, both shown in block form in FIG. 1.

In an illustrative example, innovation generator 206 may apply one or more rules in policy 134 that identifies other challenges related to challenge 104. Innovation generator 206 may identify challenge 104 as related to challenge 212 based on application of policy 134 to a comparison of tags 136 of challenge 104 to tags 214 of challenge 212. Tags 214 are keywords or terms associated with challenge 212 that generally indicate the subject matter of challenge 212. In this illustrative example, innovation generator 206 identifies challenge 212 as related to challenge 104 based on an application of policy 134 to a comparison of tags 136 with tags 214. Comparison of tags 136 with tags 214 may be based on an application of policy 134 to determine an overlap between tags 136 of challenge 104 and tags 214 of challenge 212.

Based upon an application of policy 134, innovation generator 206 can link challenge 104 with challenge 212 to create workflow 210. Workflow 210 is a data structure comprising an aggregation of similar challenges. As depicted, workflow 210 comprises challenge 104 and challenge 212. In an illustrative example, workflow 210 is a tag created by tag module 204 that creates a hierarchical aggregation of similar challenges to promote collaborative effort on workflow 210 among cross-organizational teams within organization 114, in order to achieve goals 115 of organization 114. In an illustrative example, workflow 210 may indicate keywords or terms associated with workflow 210 that generally indicate at least one of the subject matter of workflow 210 and information contained within workflow 210 based on an overlap between tags 136 of challenge 104 and tags 138 of objects 112.

In this illustrative example, as similar challenges are merged into a common workflow, viral workflow generator 118 increases the visibility of the workflow within organization 114. For example, as operator 208 performs actions with respect to workflow 210, innovation generator 206 associates sheets those actions with both challenge 104 and challenge 212. Innovation generator 206 therefore publishes user input 128 related to challenge 104 to other personnel associated with challenge 104 and challenge 212, regardless of whether the other personnel are connections 116 within personal network 108 of operator 208. As used herein, other personnel may be associated with a particular challenge when they take actions with respect to challenge 104, such as but not limited to, sharing challenge 104 among connections 116, following challenge 104, promoting challenge 104 two connections 116, commenting on challenge 104, and registering to contribute to challenge 104. In an illustrative example, the actions performed by operator 208 affecting workflow 210 can be presented within a graphical user interface 126, of other personnel associated with both challenge 104 and challenge 212.

Innovation generator 206 therefore provides the social tools to make challenge 104 and challenge 212 viral in nature. As additional similar challenges are aggregated into the common workflow 210, including both challenge 104 and challenge 212, workflow 210 becomes more widely exposed throughout organization 114. By leveraging individual connections among personal network 108 for each of operators 208, workflow 210 grows in visibility as at least one of challenge 104 or challenge 212 is shared within organization 114.

Innovation generator 206 enables identification of trending activity 216 based on statistics 132 recorded by activity tracker 202. Trending activity 216 is a challenge or workflow, such as challenge 104, challenge 212, or workflow 210, that is identified based on an analysis of all actions performed by any of objects 112 with respect to trending activity 216 over a selected time period.

In an illustrative example, innovation generator 206 applies a group of rules in policy 134 to statistics 132 for each of challenge 104, challenge 212, and workflow 210. Based on the results of applying the group of rules to statistics 132, innovation generator 206 identifies at least one of challenge 104, challenge 212, and workflow 200 can as trending activity 216.

For example, one rule in policy 134 may identify workflow 210 as a trending activity 216 based on an analysis of all actions performed by any of objects 112 with respect to workflow 210 over a selected time period. Innovation generator 206 determines trending activity 216 based on an analysis of statistics 132 for workflow 210. The selected time period is at least one of 30 days, 1 month, 1 day, 1 week, 3 months, 1 year, or some other suitable time period for identifying trending activity 216.

In this illustrative example, workflow 210 is identified as trending activity 216, viral workflow generator 118 increases the visibility of the workflow 210 within organization 114. For example, workflow generator 118 can display trending activity 216 to additional personnel who have demonstrated an interest in topics were subject matter similar to those contained in workflow 210. Viral workflow generator 118 can display trending activity 216 within a graphical user interface 126 for additional personnel of organization 114 based on an overlap of at least one of tags 136, tags 214, and workflow 210 with other challenges and workflows in which the additional personnel have expressed interest through user input, such as user input 128.

Additionally, as depicted, viral workflow generator 118 can display trending activity will 216 within a graphical user interface 126 of managers 218. By displaying trending activity 216 within a graphical user interface 126 for managers 218, viral workflow generator 118 ensures guidance and control over employee driven innovations at an organizational level. In the illustrative example, viral workflow generator 118 facilitates alignment of workflow 210 with goals 115 of organization 114 by allowing managers 218 certain administrative control over trending activity 216. Managers 218 may take actions with respect to workflow 210, such as but not limited to, sharing workflow 210 among connections 116, following workflow 210, promoting workflow 210 to connections 116, commenting on workflow 210, and registering to contribute to workflow 210. Furthermore, if workflow 210 is not aligned with goals 115 of organization 114, managers 218 may take additional actions, limiting the distribution and visibility of workflow 210 within organization 114. For example, in an illustrative embodiment, managers 218 may delete at least one of workflow 210, challenge 104, and challenge 212 from database 130.

Innovation generator 206 therefore provides the social tools to make challenge 104 and challenge 212 viral in nature as workflow 210 becomes more widely exposed throughout organization 114. By leveraging individual connections among personal network 108 for each of operators 208, workflow 210 can grow in visibility as at least one of challenge 104 or challenge 212 is shared within organization 114.

In this illustrative example, at least one of challenge 104, challenge 212, and workflow 210 may be relied on for making decisions on operations 142 that should be performed or pursued in furtherance of goals 115 of organization 114, all shown in block form in FIG. 1. As a result, innovation generator 206 supports employee driven innovation within an organization, fueling bottom-up innovative ideas that can potentially transform the organization. In this manner, innovation generator 206 provides the social tools to make a challenge or workflow viral in nature. By leveraging individual connections, a challenge can grow in visibility as it is shared within the company. Performing operation 142 for organization 114 is enabled based on the submission of challenge 104 by person 106, as well as the growing visibility of challenge 104 among other people within an organization 114.

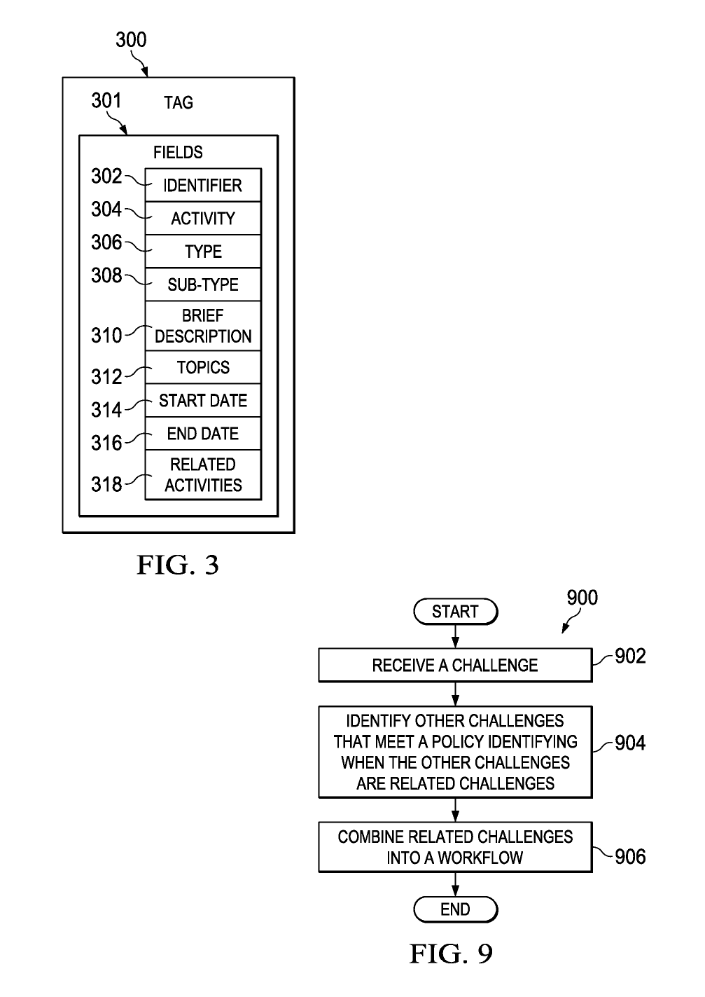

Turning to FIG. 3, an illustration of a block diagram of a tag is depicted in accordance with an illustrative embodiment. As depicted, tag 300 is an example of one implementation for at least one of tags 136 and tags 138, both shown in block form in FIG. 1.

In this illustrative example, tag 300 includes a number of different fields 301. As depicted, fields 301 include identifier 302, activity 304, type 306, sub-type 308, brief description 310, topics 312, start date 314, end date 316, and related activities 318. Identifier 302 is a unique identifier for the tag. This unique identifier is selected from at least one of a number, an alpha-numeric string, or any other suitable type of identifier for the tag.

Activity 304 is the challenge or workflow identified by the tag. For example, activity 304 may be selected from challenge 104, challenge 212, and Workflow 210, each shown in block form in FIG. 2.

Type 306 is the categorical name of a subset of tags 138 of FIG. 1. In this illustrative example, type 306 is selected from at least one of technical, workplace, community, or some other suitable name for a group of tags. Sub-type 308 is the name of a group of tags within type 306. In this illustrative example, when type 306 for the tag is community, sub-type 308 can be selected from at least one of hobbies or interests. When type 306 for the tag is technical, sub-type 308 can be selected from at least one of skills, education, licensing, certification, language, or other suitable sub-types for information about professionals. When type 306 for the tag is workplace, sub-type 308 can be selected from at least one of market share, innovation, productivity, resources, profitability, management, employees, and social responsibility.

Brief description 310 generally indicates the subject matter of activity 304. Topics 312 are keywords or terms associated with activity 304 and derived from brief description 310 that categorically indicate at least one of the subject matter of activity 304, content of activity 304, and information contained within activity 304.

In this illustrative example, start date 314 in tag 300 is a date that specifies when activity 304 represented by the tag 300 is valid for the challenge or workflow. End date 316 in tag 300 is a date that specifies when activity 304 represented by tag 300 is no longer valid for the challenge or workflow.

For example, when start date 314 is in the past and end date 316 is in the future, these dates indicate that activity 304, represented by tag 300, is currently valid. As another example, when these dates are both in the past, these dates indicate that activity 304 represented by tag 300 is no longer current or valid for the challenge or workflow.

These dates may be based on a rule in policy 134 for the validity of activity 304. For example, tag module 204 may generate start date 314 and end date 316. When these dates are in the past, tag module 204 may remove the tag 300 from tags 138, shown in block form in FIG. 1.

As depicted, related activities 318 are the challenges and Workflows related to activity 304. For example, related activities 318 may include zero, one, or any other number of related challenges and Workflows. In an illustrative embodiment, related activities 318 include a list of unique identifiers, such as identifier 302, for tags of each challenge and Workflow related to activity 304.

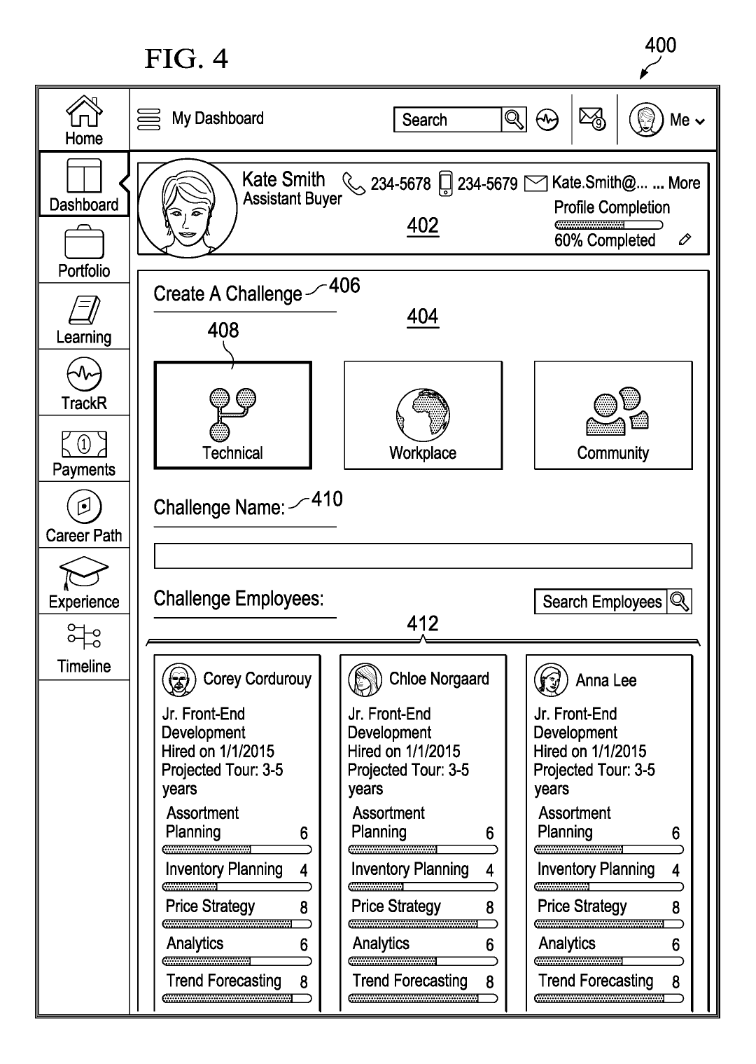

FIGS. 4-8 are illustrative examples of a graphical user interface that may be used to as create and access challenges and workflow in order to identify and encourage employee driven innovation within an organization. With reference first to FIG. 4, an illustration of a graphical user interface for creating a challenge is depicted in accordance with an illustrative embodiment. As depicted, graphical user interface 400 is an example of one implementation for graphical user interface 126 creating challenge 104, both shown in block form in FIG. 1.

In this illustrative example, graphical user interface 400 displays a number of different graphical elements. As depicted, graphical user interface 400 includes person 402 and challenge creation frame 404.

Person 402 is an example of person 106 shown in block form in FIG. 1. As depicted, graphical user interface 400 displays an image and a name for person 402. Person 402 corresponds to one of objects 112, shown in block form in FIG. 1. Graphical user interface 400 may retrieve the image and the name for person 402 by accessing the corresponding one of objects 112.

Challenge creation frame 404 is a portion of graphical user interface 400 through which person 402 can submit challenge 406. Challenge 406 is an example of challenge 104 shown in block form in FIG. 1. Challenge creation frame 404 allows persons 402 to enter details about challenge 406 through user input 128, shown in block form in FIG. 1. In this illustrative example, challenge creation frame 404 includes a number of different graphical elements. As depicted, challenge creation frame 404 includes challenge type 408, challenge name 410, and challenge participants 412.

Challenge type 408 is a category into which challenge 406 is classified based on a business need of organization 114 two which challenge 406 pertains. In an illustrative example, challenge type 408 corresponds to one of goals 115 of organization 114, shown in block form in FIG. 1. As depicted, challenge type 408 is selected from one of a technical challenge, a workplace challenge, and a community challenge. Person 402 can interact with challenge type 408 through user input 128 in order to populate type 306 and sub-type 308 of fields 301.

Challenge name 410 is a unique identifier for challenge 406. Challenge name 410 can be selected by person 402 from at least one of a number, an alpha-numeric string, or any other suitable type of unique identifier for challenge 406. Person 402 can interact with challenge name 410 through user input 128 in order to populate activity 304 of fields 301.

Challenge participants 412 are selected by person 402 from connections 116 of personal network 108, shown in block form in FIG. 1 of person 402. Challenge participants 412 are ones of connections 116 with whom person 402 has elected to share challenge 406. As depicted, challenge participants 412 include connection 414, connection 416, and connection 418.

By sharing challenge 406 with challenge participants 412, person 402 increases the visibility of challenge 406 across organization 114. As person 402 performs actions with respect to challenge 406, those actions become visible to challenge participants 412. In an illustrative example, the actions performed by person 402 can be presented within a graphical user interface 126, shown in block form in FIG. 1, for each of challenge participants 412.

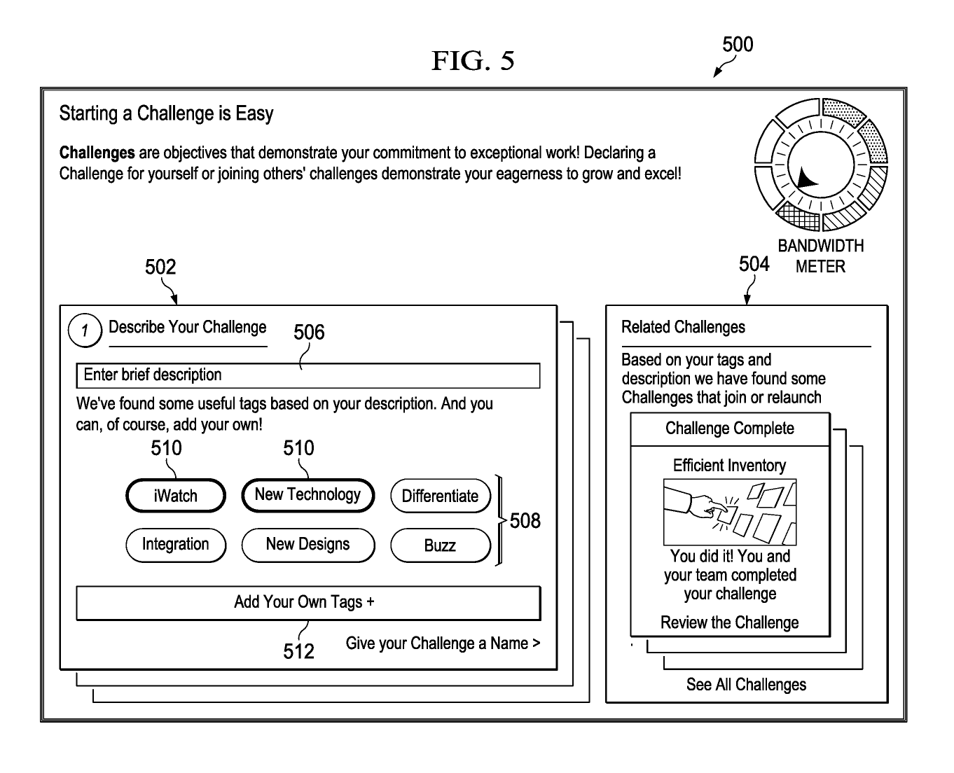

With reference now to FIG. 5, an illustration of a graphical user interface for submitting a challenge to a workflow generator is depicted in accordance with an illustrative embodiment. As depicted, graphical user interface 500 is an example of one implementation for graphical user interface 126, shown in block form in FIG. 1, for submitting challenge 406 of FIG. 4.

In this illustrative example, graphical user interface 500 displays a number of different graphical elements. As depicted, graphical user interface 500 includes challenge description 502 and related challenges 504.

As depicted, challenge description 502 includes brief description 506 provided by person 106 for challenge 104. Brief description 506 generally indicates the subject matter of challenge 406. Person 402 can interact with brief description 506 through user input 128 in order to populate brief description 310 of fields 301, both shown in block form in FIG. 3.

Based on brief description 506, viral workflow generator 118 identifies a subset of tags 138, both shown in block form in FIG. 1, and displays this subset within a graphical user interface 500 as suggested tags 508. Suggested tags 508 are a subset of tags 138 identified from keywords or terms within brief description 506 that overlap with keywords or terms of suggested tags 508. Person 402 can select at least one of suggested tags 508 to associate with challenge 406. As depicted, selected tags 510 have been indicated from suggested tags 508. By interacting with selected tags 510, Person 402 can populate related activity 318 of fields 301, both shown in block form in FIG. 3, within selected tags 510 to include challenge 406.

Additionally, challenge description 502 includes button 512. Interaction with button 512 through user input 128 allows person 402 create additional tags that reference challenge 406, when those additional tags are not included in suggested tags 508.

Related challenges 504 are the challenges and Workflows related to challenge 406. Related challenge 504, such as challenge 212, shown in block form in FIG. 2, may be identified based on brief description 506 of challenge 406 as well as selected tags 510. In an illustrative embodiment, viral workflow generator 118 identifies related challenges 504 based on an overlap between selected tags 510 of challenge 406 and tags of associated with related challenges 504.

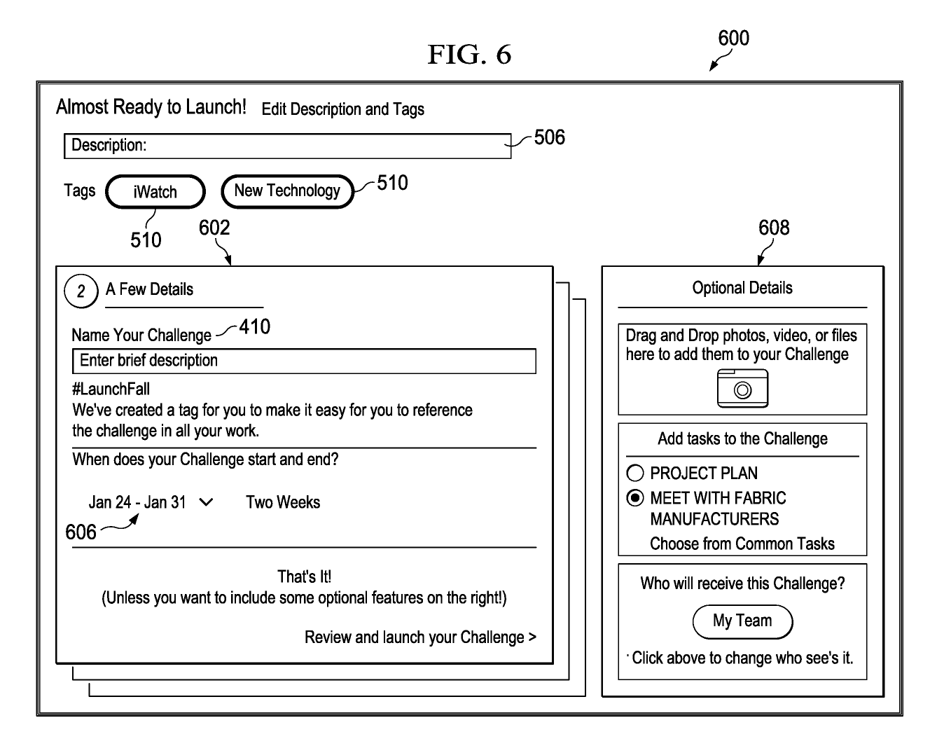

With reference now to FIG. 6, an illustration of a graphical user interface for entering challenge details is depicted in accordance with an illustrative embodiment. As depicted, graphical user interface 600 is an example of one implementation for graphical user interface 126, shown in block form in FIG. 1, finalizing submission of challenge 406 of FIG. 6.

In this illustrative example, graphical user interface 600 displays a number of different graphical elements. As depicted, graphical user interface 600 includes brief description 506, selected tags 510, and challenge details 602. As depicted, challenge details 602 includes challenge name 410, challenge dates 606, and optional details 608.

Challenge dates 606 are dates that specify when challenge 104 is valid and no longer valid. For example, when challenge dates 606 indicate a starting date that is in the past and ending date that is in the future, challenge 104 is currently valid. When challenge 104 is valid, an operator, such as operator 208 shown in block form in FIG. 2, can perform actions with respect to challenge 104 to create a viral workflow. These actions can be for example but not limited to, at least one of viewing challenge 104, posting ideas to challenge 104, posting comments to challenge 104, uploading files to challenge 104, sharing challenge 104 with connections 116 within personal network 108, and associating challenge 104 with other challenges within database 130, shown in block form in FIG. 1. As another example, when challenge dates 606 indicate both a starting date and an ending date that is in the past, challenge 104 is no longer valid. When challenge 104 is no longer valid, operator 208 cannot submit additional actions with respect to challenge 104 without first updating challenge dates 606. Person 402 of FIG. 4 can interact with challenge dates 606 through user input 128 in order to populate start date 314 and end date 316 of fields 301, all shown in block form in FIG. 3.

As depicted, challenge details 602 also includes optional details 608. Optional details 608 allows person 106 to perform actions with respect to challenge 406, such as for example but not limited to, at least one of viewing challenge 406, posting ideas to challenge 406, posting comments to challenge 406, and uploading files to challenge 406.

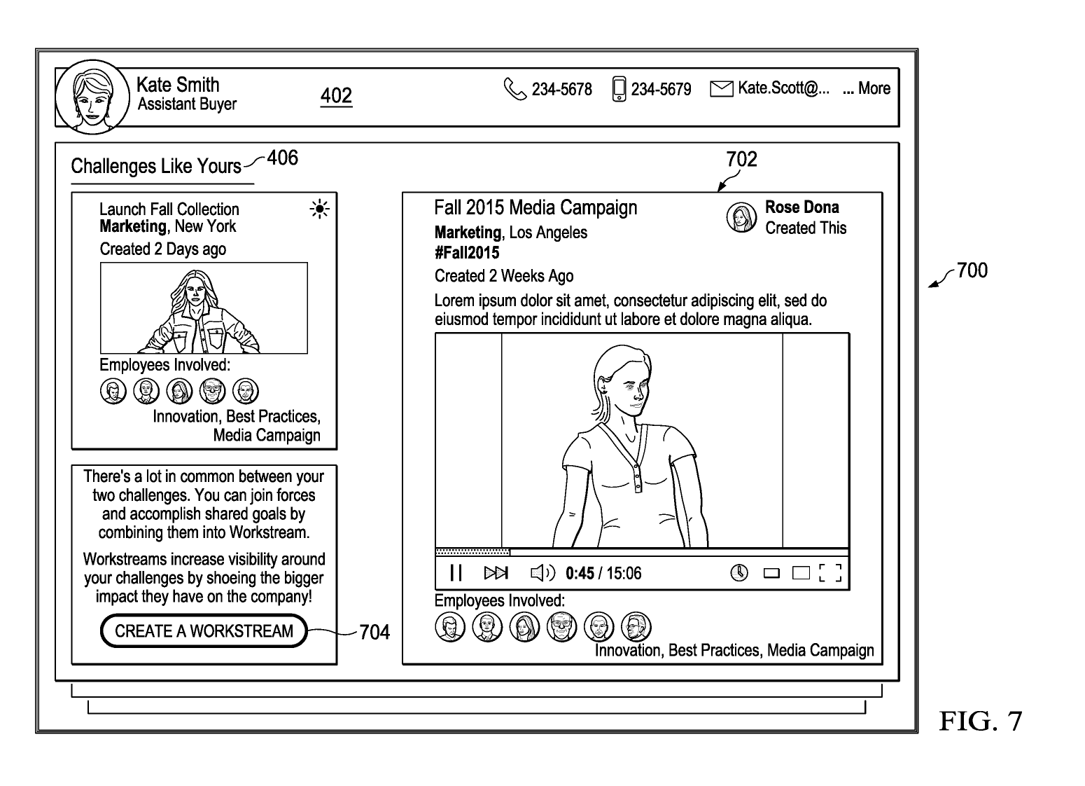

With reference now to FIG. 7, an illustration of a graphical user interface for merging challenges into a workflow is depicted in accordance with an illustrative embodiment. As depicted, graphical user interface 700 is an example of one implementation for graphical user interface 126, shown in block form in FIG. 1, for creating a workflow, such as workflow 210 shown in block form in FIG. 2.

In this illustrative example, graphical user interface 700 displays a number of different graphical elements. As depicted, graphical user interface 700 includes person 402, challenge 406, challenge 702, and button 704.

As depicted, challenge 406 is displayed within a graphical user interface 700 after submission by person 402.

In an illustrative example, innovation generator 206, shown in block form in FIG. 2, may apply one or more rules in policy 134 that identifies challenge 702 based on an overlap between selected tags 510 shown in FIG. 5 of challenge 406 and tags of challenge 702. As depicted, graphical user interface 700 displays challenge 702 as related to challenge 406 based on an application of policy 134 comparing selected tags 510 with tags for challenge 702.

Graphical user interface 700 includes button 704. Button 704 is an interactive graphical element displayed within a graphical user interface 700. Interaction with button 704 through user input 128 allows person 402 to link challenge 406 with challenge 702 to create workflow, such as workflow 210 shown in graphical block form in FIG. 2.

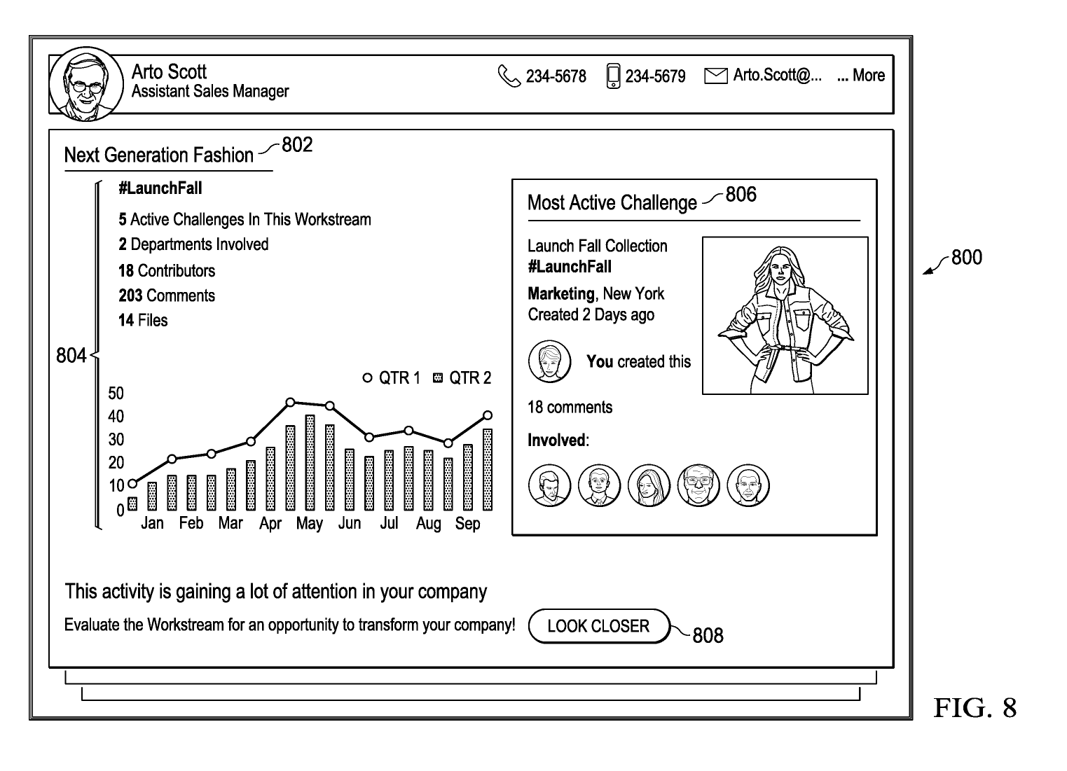

With reference now to FIG. 8, an illustration of a graphical user interface for displaying a workflow is depicted in accordance with an illustrative embodiment. As depicted, graphical user interface 800 is an example of one implementation for graphical user interface 126, shown in block form in FIG. 1, for displaying workflow 802. Workflow 802 is an example of one implementation for workflow 210, shown in block form in FIG. 2.

In this illustrative example, workflow 802 is created by linking challenge 406 and challenge 702 through user input 128 interacting with button 704 of graphical user interface 700 shown in FIG. 7. In this illustrative example, graphical user interface 800 displays a number of different graphical elements related to workflow 802. As depicted, graphical user interface 800 displays workflow overview 804, primary challenge 806, and workflow evaluation 808.

Workflow overview 804 is a graphical breakdown of relevant information and statistics related to workflow 802. As depicted, workflow overview 804 includes a number of act challenges in workflow 802, a number of departments involved in workflow 802, a number of contributors to workflow 802, a number of comments regarding workflow 802, and a number of files associated with workflow 802.

Primary challenge 806 is an indication of the most active challenge associated with workflow 802. In this illustrative example, innovation generator 206 may apply one or more rules in policy 134, both shown in block form in FIG. 2, that identifies either challenge 406 or challenge 702 based on statistics 132, shown in block form in FIG. 1.

Workflow evaluation 808 is an interactive graphical element that allows person 402 to view goals 115 of organization 114, both shown in block form in FIG. 1, that are potentially impacted by workflow 802. In this manner, operations 142 perform with respect to organization 114 are enabled based on the impact of workflow 802 on goals 115.

Turning next to FIG. 9, an illustration of a flowchart of a process for identifying related challenges and merging challenges into a workflow is depicted in accordance with an illustrative embodiment. Process 900 illustrated in FIG. 9 may be implemented in workflow environment 100 shown in block form in FIG. 1. Process 900 may be used to enable operations for organization 114. In particular, the process may be implemented in viral workflow generator 118 in computer system 120.

The process begins by receiving a challenge (step 902). The process then identifies other challenges that meets a policy identifying when the other challenges are related challenges (step 904). The process combines the related challenges into a workflow (step 906) with the process terminating thereafter. In this manner, performing an action in the organization based on employee driven innovations identified and distributed within a workflow is enabled.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

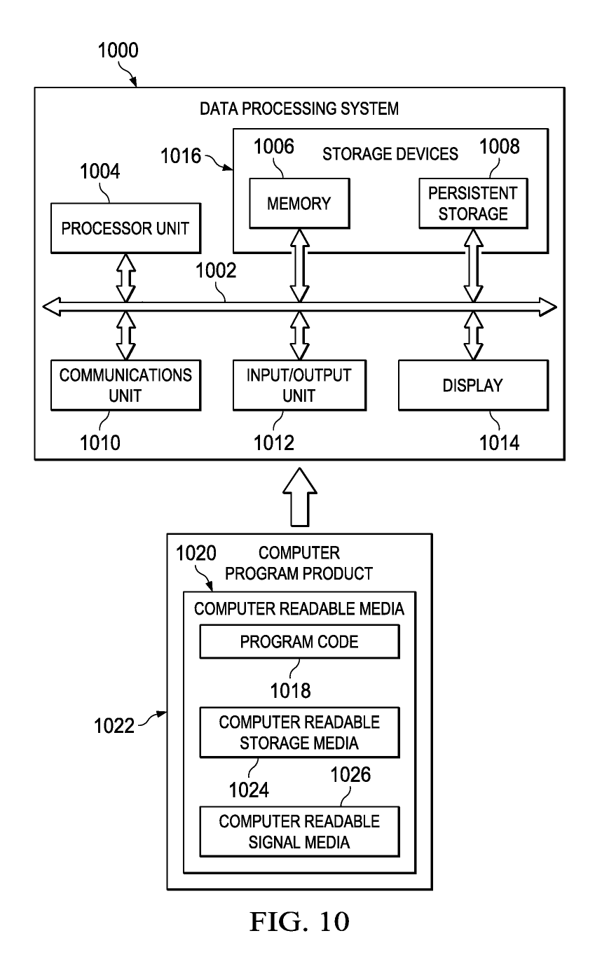

Turning now to FIG. 10, an illustration of a block diagram of a data processing system is depicted in accordance with an illustrative embodiment. Data processing system 1000 may be used to implement computer system 120 in FIG. 1. In this illustrative example, data processing system 1000 includes communications framework 1002, which provides communications between processor unit 1004, memory 1006, persistent storage 1008, communications unit 1010, input/output unit 1012, and display 1014. In this example, communications framework 1002 may take the form of a bus system.

Processor unit 1004 serves to execute instructions for software that may be loaded into memory 1006. Processor unit 1004 may be a number of processors, a multi-processor core, or some other type of processor, depending on the particular implementation.

Memory 1006 and persistent storage 1008 are examples of storage devices 1016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1016 may also be referred to as computer readable storage devices in these illustrative examples. Memory 1006, in these examples, may be, for example, a random access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a flash memory, a rewritable optical disk, a rewritable magnetic tape, or some combination of the above. The media used by persistent storage 1008 also may be removable. For example, a removable hard drive may be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that may be connected to data processing system 1000. For example, input/output unit 1012 may provide a connection for user input through at least of a keyboard, a mouse, or some other suitable input device. Further, input/output unit 1012 may send output to a printer. Display 1014 provides a mechanism to display information to a user.

Instructions for at least one of the operating system, applications, or programs may be located in storage devices 1016, which are in communication with processor unit 1004 through communications framework 1002. The processes of the different embodiments may be performed by processor unit 1004 using computer-implemented instructions, which may be located in a memory, such as memory 1006.

These instructions are referred to as program code, computer usable program code, or computer readable program code that may be read and executed by a processor in processor unit 1004. The program code in the different embodiments may be embodied on different physical or computer readable storage media, such as memory 1006 or persistent storage 1008.

Program code 1018 is located in a functional form on computer readable media 1020 that is selectively removable and may be loaded onto or transferred to data processing system 1000 for execution by processor unit 1004. Program code 1018 and computer readable media 1020 form computer program product 1022 in these illustrative examples. In one example, computer readable media 1020 may be computer readable storage media 1024 or computer readable signal media 1026.

In these illustrative examples, computer readable storage media 1024 is a physical or tangible storage device used to store program code 1018 rather than a medium that propagates or transmits program code 1018. Alternatively, program code 1018 may be transferred to data processing system 1000 using computer readable signal media 1026. Computer readable signal media 1026 may be, for example, a propagated data signal containing program code 1018. For example, computer readable signal media 1026 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1000 are not meant to provide architectural limitations to the manner in which different embodiments may be implemented. The different illustrative embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code 1018.

Thus, the illustrative examples in the different figures provide one or more technical solutions to overcome a technical problem of facilitating collaborative efforts within an organization that makes the identification identifying employee driven innovations and prevention of repetitive efforts in pursuit of organizational goals more cumbersome and time-consuming than desired. For example, viral workflows generator 118 receiving a challenge submitted from an employee. Viral workflows generator 118 then identifies other challenges that meets a policy identifying when the other challenges are related employee submitted challenge. Viral workflows generator 118 combines the related challenges into a workflow, increasing the visibility of the related challenges throughout the organization. In this manner, performing an action in the organization based on employee driven innovations identified and distributed within a workflow is enabled.

In this manner, in performing operations with respect to an organization, employee driven innovations are more quickly and accurately identified based on viral distribution throughout the organization enabling decisions to perform operations based on the Workflow in pursuit of organizational goals. In this manner, the use of viral workflows generator 118 has a technical effect of reducing time, effort, or both in facilitating collaborative efforts within an organization as well as in performing operations for an organization based on innovative employee submitted ideas to achieve goals of the organization.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for creating a viral workflow for a workforce comprising:
receiving, by a computer, a challenge from an employee for distribution among a personal network of the employee;
identifying, by the computer, at least one other challenge that is related to the challenge; and
linking, by the computer, the challenge with the at least one other challenge to create a workflow.

2. The method of claim 1, further comprising:
in response to receiving the challenge from the employee, distributing, by the computer, the challenge among the personal network of the employee.

3. The method of claim 2, wherein the personal network comprises at least one other employee, the method further comprising:
receiving, by the computer, user input about the challenge from the at least one other employee; and
in response to receiving the user input about the challenge from the at least one other employee, increasing, by the computer, a visibility of the viral workflow within an organization.

4. The method of claim 3, wherein the user input comprises at least one of viewing the challenge by the at least one other employee, posting ideas to the challenge by the at least one other employee, posting comments to the challenge by the at least one other employee, uploading files to the challenge by the at least one other employee, sharing the challenge by the at least one other employee among a personal network of the at least one other employee.

5. The method of claim 3, the method further comprising:
identifying, by the computer, statistics for the workflow
determining, by the computer, whether the challenge is a trending activity within an organization based on the statistics for the workflow.

6. The method of claim 5, the method further comprising:
in response to determining that the challenge is a trending activity, distributing, by the computer, the challenge to additional personnel, wherein the additional personnel have demonstrated an interest in topics having subject matter similar to those contained in the workflow.

7. The method of claim 6, further comprising:
identifying, by the computer, at least one of the additional personnel and the topics from tags associated with the challenge, wherein the tags comprise keywords that generally indicate at least one of the subject matter of the challenge and information contained within the challenge.

8. The method of claim 6, further comprising:
enabling, by the computer, making at least one business decision based on the trending activity.

9. A computer system comprising:
a display system; and
a viral workflow generator in communication with the display system, wherein the viral Workflow generator: receives a challenge from an employee for distribution among a personal network of the employee; identifies at least one other challenge that is related to the challenge; and links the challenge with the at least one other challenge to create a workflow.

10. The computer system of claim 9, wherein the viral workflow generator further:
in response to receiving the challenge from the employee, distributes the challenge among the personal network of the employee.

11. The computer system of claim 10, wherein the personal network comprises at least one other employee, wherein the viral workflow generator further:
receives user input about the challenge from the at least one other employee; and in response to receiving the user input about the challenge from the at least one other employee, increases a visibility of the viral workflow within an organization.

12. The computer system of claim 11, wherein the user input comprises at least one of viewing the challenge by the at least one other employee, posting ideas to the challenge by the at least one other employee, posting comments to the challenge by the at least one other employee, uploading files to the challenge by the at least one other employee, sharing the challenge by the at least one other employee among a personal network of the at least one other employee.

13. The computer system of claim 10, wherein the viral Workflow generator further:
identifies statistics for the workflow; and determines whether the challenge is a trending activity within an organization based on the statistics for the workflow.

14. The computer system of claim 13, wherein the viral Workflow generator further:
in response to determining that the challenge is a trending activity, distributing the challenge to additional personnel, wherein the additional personnel have demonstrated an interest in topics having subject matter similar to those contained in the workflow.

15. The computer system of claim 14, wherein the viral Workflow generator further:
identifies at least one of the additional personnel and the topics from tags associated with the challenge, wherein the tags comprise keywords that generally indicate at least one of the subject matter of the challenge and information contained within the challenge.

16. The computer system of claim 14, wherein the viral Workflow generator:
enables making at least one business decision based on the trending activity.

17. A computer program product for creating a viral workflow for a workforce, the computer program product comprising:
a computer readable storage media;
first program code, stored on the computer readable storage media, for receiving a challenge from an employee for distribution among a personal network of the employee;
second program code, stored on the computer readable storage media, for identifying at least one other challenge that is related to the challenge; and
third program code, stored on the computer readable storage media, for linking the challenge with the at least one other challenge to create a workflow.

18. The computer program product of claim 17, further comprising:
fourth program code, stored on the computer readable storage media, for distributing the challenge among the personal network of the employee in response to receiving the challenge from the employee.

19. The computer program product of claim 18, wherein the personal network comprises at least one other employee, the computer program product further comprising:
fifth program code, stored on the computer readable storage media, for receiving user input about the challenge from the at least one other employee; and
sixth program code, stored on the computer readable storage media, for increasing a visibility of the viral workflow within an organization in response to receiving the user input about the challenge from the at least one other employee.

20. The computer program product of claim 19, wherein the user input comprises at least one of viewing the challenge by the at least one other employee, posting ideas to the challenge by the at least one other employee, posting comments to the challenge by the at least one other employee, uploading files to the challenge by the at least one other employee, sharing the challenge by the at least one other employee among a personal network of the at least one other employee.

21. The computer program product of claim 19, further comprising:
seventh program code, stored on the computer readable storage media, for identifying statistics for the workflow; and
eighth program code, stored on the computer readable storage media, for determining whether the challenge is a trending activity within an organization based on the statistics for the workflow.

22. The computer program product of claim 21, further comprising:
ninth program code, stored on the computer readable storage media, for distributing the challenge to additional personnel in response to determining that the challenge is a trending activity, wherein the additional personnel have demonstrated an interest in topics having subject matter similar to those contained in the workflow.

23. The computer program product of claim 22, further comprising:
tenth program code, stored on the computer readable storage media, for identifying at least one of the additional personnel and the topics from tags associated with the challenge, wherein the tags comprise keywords that generally indicate at least one of the subject matter of the challenge and information contained within the challenge.

24. The computer program product of claim 22, further comprising:
tenth program code, stored on the computer readable storage media, for enabling making of at least one business decision based on the trending activity.
